(19) United States
(12) Patent Application Publication
(10) Pub. No.: US 2014/0129368 A1
(43) Pub. Date: May 8, 2014

(54) METHOD AND SYSTEM FOR PERFORMING ONLINE INTERVENTION

(71) Applicant: Jadav Manirao SAMPATH, Bangalore (IN)

(72) Inventor: Jadav Manirao SAMPATH, Bangalore (IN)

(73) Assignee: Jadav Manirao Sampath, Bangalore (IN)

(21) Appl. No.: 13/733,912

(22) Filed: Jan. 4, 2013

(30) Foreign Application Priority Data
Nov. 5, 2012 (IN) 4628/CHE/2012

(51) Int. Cl. G06Q 30/06

(52) U.S. Cl. CPC G06Q 30/0621
USPC 705/26.5

(57) ABSTRACT

A method and system for performing online intervention based on a life situation. The method includes receiving an input from a first user, the input including a situational parameter; retrieving a product based on the situational parameter; enabling selection of a product from the list of products; affixing a personalized message to the product; and transmitting the product to the second user. The system includes an electronic device, a communication interface, a memory and a processor to receive an input, to retrieve a product based on a situational parameter, to enabling selection of a product from the list of products, to affix a personalized message to the product and to transmit the product to the second user.

### TECHNICAL FIELD

Embodiments of the disclosure relate to the field of online intervention based on a life situation of an individual and more specifically, to conveying an intervention message that enables the individual to provide a response to the life situation.

### BACKGROUND

As lives of individuals include numerous life situations, it becomes increasingly essential for intervention of a user into the lives of the individuals. The intervention, of the user, enables the user to provide support and encouragement, to the individuals, during the life situations. The intervention enables the individuals to respond to the life situations.

In recent times, Internet is been widely used for greeting one or more individuals on various occasions. In one example, a user can send an electronic-card (e-card), to the individuals, via an electronic mail. The user can also use different application programs for sending the e-card to the individuals. In another example, various gift articles can also be sent online, to the individuals, for the occasions. The gift articles can also be engraved with messages that are relevant to the occasions.

In the light of the foregoing discussion, there is a need for a method and a system for online intervention, of a user, based on a life situation.

### SUMMARY

The above-mentioned needs are met by a method, a computer program product and a system for performing online intervention.

An example of a method of performing online intervention includes receiving an input from a first user, the input including a situational parameter. The method also includes retrieving a list of products based on the situational parameter. The situational parameter represents a life situation of the second user. Further, the method includes enabling selection of a product from the list of products, the product being integrated with a message medium. The message medium further including an intervention message that enables the online intervention, of the first user, into the life situation of the second user. Furthermore, the method includes affixing a personalized message to the product. Moreover, the method includes transmitting the product to the second user.

Another example of a method of performing online intervention includes determining a status, of a second user, on a social networking site. The status includes one or more keywords that determine a life situation of the second user. The method also includes retrieving a list of products based on the life situation of the second user. Further, the method includes enabling selection of a product from the list of products, the product being integrated with a message medium. The message medium further including an intervention message that enables the online intervention, of a first user, into the life situation of the second user. The method further includes affixing a personalized message to the product. Moreover, the method includes transmitting the product to the second user.

An example of a computer program product stored on a non-transitory computer-readable medium that when executed by a processor, performs a method of performing online intervention includes receiving an input from a first user, the input including a situational parameter. The computer program product also includes retrieving a list of products based on the situational parameter. The situational parameter represents the life situation of the second user. Further, the computer program product includes enabling selection of a product from the list of products, the product being integrated with a message medium. The message medium further including an intervention message that enables the online intervention, of the first user, into the life situation of the second user. Furthermore, the computer program product includes affixing a personalized message to the product. Moreover, the computer program product includes transmitting the product to the second user.

Another example of a computer program product stored on a non-transitory computer-readable medium that when executed by a processor, performs a method of performing online intervention includes determining a status, of a second user, on a social networking site. The status includes one or more keywords that determine a life situation of the second user. The computer program product also includes retrieving a list of products based on the life situation of the second user. Further, the computer program product includes enabling selection of a product from the list of products, the products being integrated with a message medium. The message medium further including an intervention message that enables the online intervention, of the first user, into the life situation of the second user. Furthermore, the computer program product includes affixing a personalized message to the product. Moreover, the computer program product includes transmitting the product to the second user.

An example of a system for performing online intervention includes an electronic device. The system also includes a communication interface in electronic communication with the electronic device. The system further includes a memory that stores instructions. Further, the system includes a processor responsive to the instructions to receive an input from a first user, the input including a situational parameter. The processor is also responsive to the instructions to retrieve a list of products based on the situational parameter. The situational parameter represents the life situation of the second user. The processor is further responsive to the instructions to enable selection of a product from the list of products, the product being integrated with a message medium. The message medium further including an intervention message that enables the online intervention, of the first user, into the life situation of the second user. Further, the processor is responsive to the instructions to affix a personalized message to the product. Furthermore the processor is responsive to the instructions to transmit the product to the second user.

### BRIEF DESCRIPTION OF THE FIGURES

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, in accordance with which various embodiments can be implemented;

FIG. 2 is a block diagram of a server, in accordance with one embodiment;

FIG. 3 is a flow diagram illustrating a method of performing online intervention, in accordance with one embodiment; and

FIG. 4 is a flow diagram illustrating a method of performing online intervention, in accordance with another embodiment.

### DETAILED DESCRIPTION OF THE EMBODIMENTS

The above-mentioned needs are met by a method, computer program product and system for performing online intervention. The following detailed description is intended to provide example implementations to one of ordinary skill in the art, and is not intended to limit the invention to the explicit disclosure, as one or ordinary skill in the art will understand that variations can be substituted that are within the scope of the invention as described.

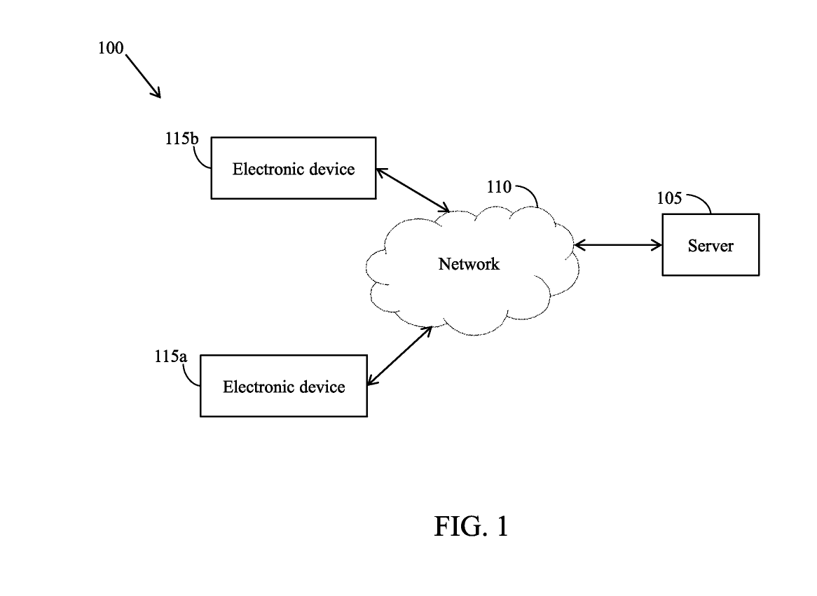

FIG. 1 is a block diagram of an environment 100, in accordance with which various embodiments can be implemented.

The environment 100 includes a server 105 an electronic device 115a and an electronic device 115b. The electronic device 115a and the electronic device 115b can communicate with the server 105 through a network 110. Examples of the electronic device 115a and the electronic device 115b include, but are not limited to, a computer, a mobile phone, a laptop, a palmtop, a hand held device and a personal digital assistant (PDA).

The server 105 is in electronic communication with the electronic device 115a and the electronic device 115b through the network 110. The server 105 can be located remotely with respect to the electronic device 115. Examples of the network 110 include, but are not limited to, a Local Area Network (LAN), a Wireless Local Area Network (WLAN), a Wide Area Network (WAN), internet, and a Small Area Network (SAN).

In some embodiments, the electronic device 115a can perform functions of the server 105.

A first user of the electronic device 115a accesses a webpage and enters a situational parameter. The situational parameter is entered in a search box present in the webpage. The situational parameter represents a life situation of a second user.

The first user can also enter the situational parameter through a mobile application included in the electronic device 115a.

The situational parameter is provided using a keyword, a phrase or selection of a situational category from a pre-defined list of situational categories.

In one example, the first user can type the keyword or the phrase in the search box. In another example, the first user can click on the situational category from the pre-defined list of situational categories displayed on the webpage or on the mobile application. The situational category clicked by the first user is considered as the situational parameter.

The situational parameter is communicated to the server 105 through the network 110 by the electronic device 115a in response to the user inputting the situational parameter.

Upon communicating the situational parameter, the server 105 is configured to retrieve a list of products based on the situational parameter. Examples of the product include, but are not limited to, greeting cards, story cards, e-cards, gift articles and accessories.

The server 105 is also configured to enable selection of a product from the list of products. The product is further integrated with a message medium. Examples of the message medium include, but are not limited to, stories, anecdotes, quotes, photographs, pictures, poems paintings and videos. The message medium, integrated into the product, is relevant to the life situation of the second user. The message medium also includes an intervention message that enables online intervention, of the first user, into the life situation of the second user.

The server is also configured to affix a personalized message, provided by the first user, to the product. The personalized message is used to convey information in context of the product. Further, the server is also configured to transmit the product to the electronic device 115b through the network 110.

Further, upon transmission of the product, the second user can access the intervention message and the personalized message through the electronic device 115b. By transmitting the product that includes the intervention message, the first user is enabled to make a meaningful intervention into the life situation of the second user. The meaningful intervention enables the second user to view another perspective of the life situation. Also, the meaningful intervention of the first user enables the second user to cope and overcome the life situation. Further, the meaningful intervention can also enable the second user to lead an enhanced life.

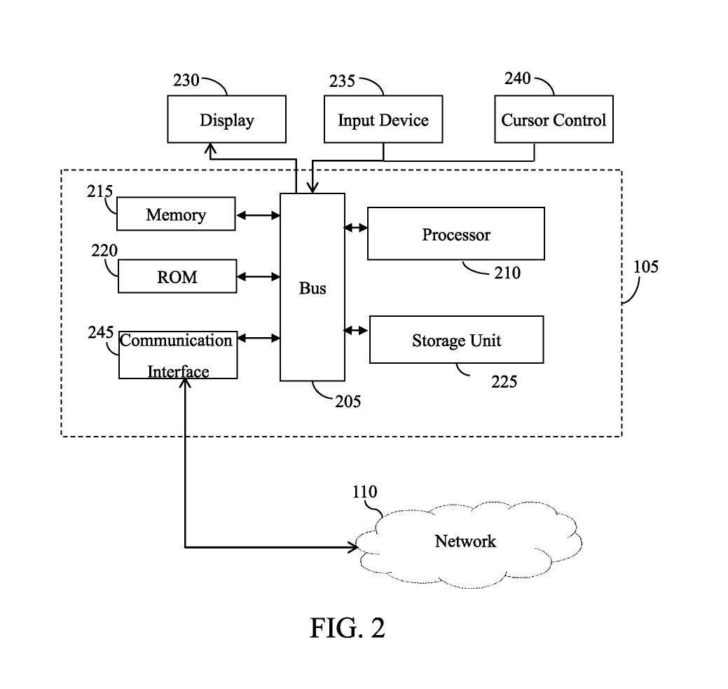

The server 105, including a plurality of elements, for performing online intervention based on a life situation, is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example various keywords, phrases and a list of situational categories.

The server 105 can be coupled via the bus 205 to a display 230, for example a cathode ray tube (CRT), for displaying a list of products to a first user. The input device 235, including alphanumeric and other keys, is coupled to the bus 205 for communicating information and command selections to the processor 210. Another type of user input device is the cursor control 240, for example, but are not limited to, a mouse, a trackball, a touch interface, gesture based interface, or cursor direction keys for communicating direction information and command selections to the processor 210 and for controlling cursor movement on the display 230.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that include the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. In any such implementation, the communication interface 245 sends and receives electrical, electromagnetic or optical signals that carry digital data streams representing various types of information.

The processor 210 in the server 105 is configured to receive an input from the first user. The input includes a situational parameter that represents the life situation of a second user. The situational parameter is provided using a keyword, a phrase or selection of a situational category from the pre-defined list of situational categories.

In one embodiment, the processor 210 in the server 105 is configured to determine a status, of the second user, on a social networking site. The status includes one or more keywords that determine the life situation of the second user.

The processor 210 in the server 105 is also configured to retrieve the list of products based on the situational parameter.

In one embodiment, the processor 210 in the server 105 is configured to retrieve the list of products based on the life situation determined by the keywords included in the status.

Further, the processor 210 in the server 105 is operable to enable selection of a product from the list of products. The product is further integrated with a message medium. The message medium is relevant to the life situation of the second user. The message medium further includes an intervention message that enables online intervention, of the first user, into the life situation of the second user. The intervention message is customized for the life situation of the second user.

The processor 210 is further configured to affix a personalized message to the product. The personalized message is provided by the first user and is used to convey information in context of the product.

The processor 210 is also configured to transmit the product to the second user. By transmitting the product that includes the intervention message, the first user can intervene into the life situation of the second user such that the online intervention enables the second user cope and overcome the life situation. Further, the online intervention can also enable the second user to view another perspective of the life situation that enables the second user to lead an enhanced life.

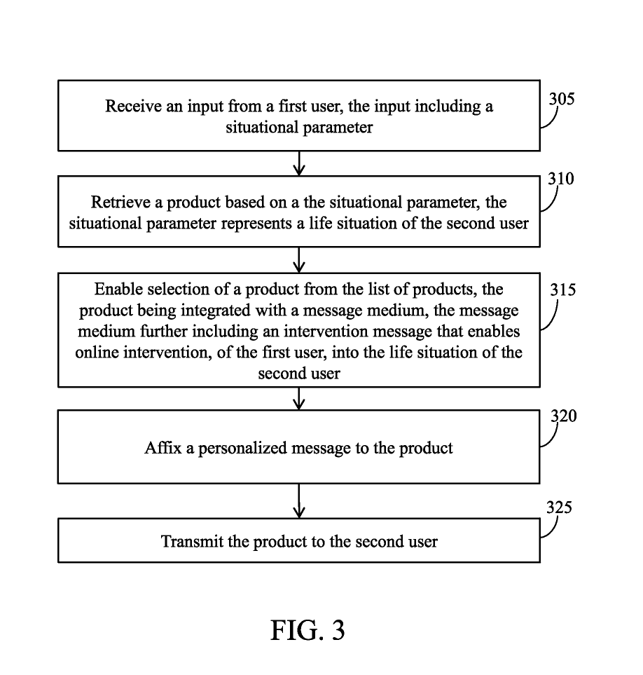

A method of enabling the online intervention based on the life situation of the second user is explained in detail in conjunction with FIG. 3.

FIG. 3 is a flow diagram illustrating a method of performing online intervention, in accordance with one embodiment.

At step 305, an input is received from a first user. The input is provided by entering a situational parameter in a search box present in a webpage. The situational parameter represents a life situation of a second user. Examples of the life situation include, but are not limited to, coping with loss, facing failure, development process, learning process and celebration.

The situational parameter is provided using a keyword, a phrase or selection of a situational category from a pre-defined list of situational categories. The pre-defined list of situational categories includes various situational parameters. The situational parameters define various life situations.

In one example, the first user can type the keyword or the phrase in the search box. In another example, the first user can click on the situational category from the pre-defined list of situational categories displayed on the webpage. The situational category clicked by the first user is considered as the situational parameter.

The first user also selects an intervention role while providing the input. Examples of the intervention role include, but are not limited to, a coach, a mentor, a teacher, a parent, a counselor, a friend, colleague, a well wisher and spouse.

Selection of the intervention role is used for the online intervention of the first user into the life situation of the second user. The first user can play the intervention role selected during the online intervention, such that the online intervention creates an impact on the life situation of the second user since the intervention role includes a personal relationship or a professional relationship between the first user and the second user.

At step 310, a list of products are retrieved based on the situational parameter. Examples of the list of products include, but are not limited to, a greeting card, a story card, an e-card, a gift article and an accessory.

At step 315, a selection of a product, from the list of products, is enabled. The product is selected by the first user. In one example, the first user can click on the product, from a list of products, displayed on the webpage. The product selected is further integrated with a message medium. Examples of the message medium include, but are not limited to, a story, an anecdote, a quote, a photograph, a picture, a poem, a painting and a video. The message medium, integrated into the product, is relevant to the life situation of the second user.

In one example, the situational parameter can include the phrase coping with loss. Upon entering the phrase, the first user can select, for example, a story card as the product. Further, the story card can include a story as the message medium. The story is relevant to the situational parameter that defines the life situation of the second user.

The message medium further includes an intervention message that enables the online intervention, of the first user, into the life situation of the second user. The online intervention message enables intervention by conveying a perspective about the life situation. The intervention message is customized for the life situation of the second user. Hence, the intervention message is inherent for each life situation.

The online intervention enables the second user to cope with the life situation, grow, overcome the life situation, learn, celebrate and be encouraged.

In one example, the life situation of the second user can include experiencing loss of a family member. In such cases, a message medium, for example a story that is relevant to the life situation of the second user is integrated into the product. The message medium further includes the intervention message. The story along with the intervention message provides the intervention, of the first user, into the life situation of the second user, such that the intervention enables the second user to cope with the loss.

At step 320, a personalized message is affixed to the product. The personalized message is provided by the first user. The personalized message is used to convey information, for example personalized thoughts, in context of the product, such that the intervention, of the first user, into the life situation of the second user is enhanced.

In one example, if the life situation of the second user includes experiencing a loss of a family member then the personalized message can include, for example, I am deeply saddened by your loss. Similarly, the first user can include various personalized thoughts based on the life situation of the second user.

At step 325, the product is transmitted to the second user. The first user can enter transmission details, for example email identifier or contact number, of the second user for transmitting the product.

Conveying the intervention message through the message medium that is integrated into the product enables the online intervention, of the first user, into the life situation of the second user via a network, for example the network 110.

The online intervention enables the second user to cope and overcome the life situation. Further, the online intervention can also enable the second user to view another perspective of the life situation that enables the second user to lead an enhanced life. Also, the first user can play various intervention roles while transmitting the product such that the intervention creates an impact in the life of the second user.

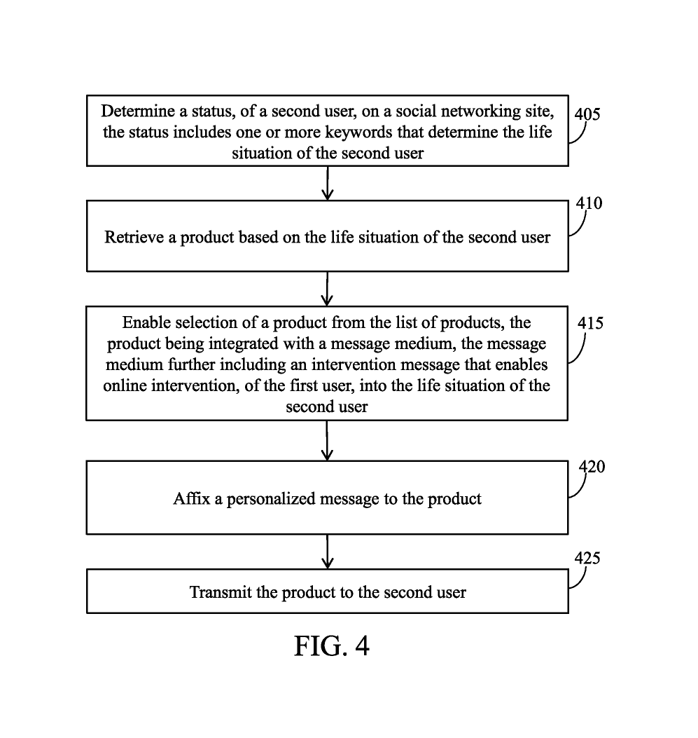

FIG. 4 is a flow diagram illustrating a method of performing online intervention, in accordance with another embodiment.

At step 405, a status, of a second user, on a social networking site, is determined. The status includes one or more keywords that determine the life situation of the second user. The one or more keywords are retrieved from the status to determine the life situation of the second user.

The one or more keywords can also be retrieved from an electronic mail or a text message.

At step 410, a list of products are retrieved based on the life situation of the second user. Examples of the product include, but are not limited to, a greeting card, a story card, an e-card, a gift article and an accessory.

At step 415, selection of a product, from the list of products, is enabled. The selection of the product, by the first user, is performed based on the life situation of the second user. The selection is performed by clicking on the product from the list of products. Further, the product is integrated with a message medium. Examples of the message medium include, but are not limited to, a story, an anecdote, a quote, a photograph, a picture, a poem, a painting and a video. The message medium, integrated into the product, is relevant to the life situation of the second user.

The message medium further includes an intervention message that enables the online intervention, of the first user, into the life situation of the second user. The online intervention, by the intervention message, is enabled by conveying a perspective about the life situation. The intervention message can also be customized for the life situation of the second user. Hence, the intervention message is inherent for each life situation.

The online intervention enables the second user to cope and overcome with the life situation. Further, the online intervention enables the second user to grow, learn, celebrate and obtain encouragement.

At step 415, a personalized message, provided by the first user, is affixed to the product. The personalized message can include information, for example personalized thoughts, in context of the product. The personalized message is provided such that the intervention, of the first user, into the life situation of the second user is enhanced.

At step 420, the product is transmitted to the second user. The first user can enter transmission details, for example email identifier or contact number, of the second user for transmitting the product.

The method specified in the present disclosure enables online intervention, of the first user, into the life situation of the second user such that the online intervention enables the second user to overcome and cope with the life situation. Further, the online intervention also enables the second user to grow, celebrate and lead an enhanced life in future. Hence, the method enables intervention that is meaningful in context to the life situation of the second user. Also, the method enables the first user to play an intervention role during the intervention. The intervention role enables the intervention to create an impact on the life situation of the second user as there is a personal relationship or a professional relationship between the first user and the second user. Hence, the first user can bring about change in life of the second user.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of performing online intervention, the method comprising:
receiving an input from a first user, the input comprising a situational parameter;
retrieving a list of products based on the situational parameter, wherein the situational parameter represents a life situation of a second user;
enabling selection of a product from the list of products, wherein the product is integrated with a message medium, the message medium further comprising an intervention message that enables the online intervention, of the first user into the life situation of the second user;
affixing a personalized message to the product; and
transmitting the product to the second user.

2. The method as claimed in claim 1 wherein receiving the input further comprises:
selecting an intervention role by the first user, wherein the intervention role enables the online intervention of the first user into the life situation of the second user.

3. The method as claimed in claim 1, wherein the product is selected, from the list of products, by the first user.

4. The method as claimed in claim 1, wherein the situational parameter is provided using one of a keyword, a phrase and selection of a situational category from a pre-defined list of situational categories.

5. The method as claimed in claim 1, wherein the intervention message is customized for the life situation of the second user.

6. The method as claimed in claim 1, wherein the personalized message is provided by the first user.

7. A method of performing online intervention, the method comprising:
determining a status, of a second user, on a social networking website, wherein the status comprises one or more keywords that determine a life situation of the second user;
retrieving a list of products based on the life situation of the second user;
enabling selection of a product from the list of products, wherein the product is integrated with a message medium, the message medium further comprising an intervention message that enables the online intervention, of the first user into the life situation of the second user;
affixing a personalized message to the product; and
transmitting the product to the second user.

8. The method as claimed in claim 7, wherein the product is selected by the first user.

9. The method as claimed in claim 7, wherein the intervention message is customized for the life situation of the second user.

10. The method as claimed in claim 7, wherein the personalized message is provided by the first user.

11. A computer program product stored on a non-transitory computer-readable medium that when executed by a processor, performs a method of performing online intervention, the method comprising:
receiving an input from a first user, the input comprising a situational parameter;
retrieving a list of product based on the situational parameter, wherein the situational parameter represents a life situation of a second user;
enabling selection of a product from the list of products, wherein the product is integrated with a message medium, the message medium further comprising an intervention message that enables the online intervention, of the first user into the life situation of the second user;
affixing a personalized message to the product; and
transmitting the product to the second user.

12. The computer program product as claimed in claim 11 wherein receiving the input further comprises:
selecting an intervention role by the first user, wherein the intervention role enables the online intervention of the first user into the life situation of the second user.

13. The computer program product as claimed in claim 11, wherein the product is selected, from the list of products, by the first user.

14. The computer program product as claimed in claim 11, wherein the situational parameter is provided using one of a keyword, a phrase and selection of a situational category from a pre-defined list of situational categories.

15. The computer program product as claimed in claim 11, wherein the intervention message is customized for the life situation of the second user.

16. The computer program product as claimed in claim 11, wherein the personalized message is provided by the first user.

17. A computer program product stored on a non-transitory computer-readable medium that when executed by a processor, performs a method of performing online intervention, the method comprising:
determining a status, of a second user, on a social networking site, wherein the status comprises one or more keywords that determine a life situation of the second user;
retrieving a list of products based on the life situation of the second user;
enabling selection of a product from the list of products, wherein the product is integrated with a message medium, the message medium further comprising an intervention message that enables the online intervention, of the first user into the life situation of the second user;
affixing a personalized message to the product; and
transmitting the product to the second user.

18. The computer program product as claimed in claim 17, wherein the product is selected, from the list of products, by the first user.

19. The computer program product as claimed in claim 17, wherein the intervention message is customized for the life situation of the second user.

20. The computer program product as claimed in claim 17, wherein the personalized message is provided by the first user.

21. A system for performing online intervention, the system comprising:
an electronic device;
a communication interface in electronic communication with the electronic device;
a memory that stores instructions; and
a processor responsive to the instructions to
receive an input from a first user, the input comprising a situational parameter;
retrieve a list of products based on the situational parameter, wherein the situational parameter represents the life situation of a second user;
enabling selection of a product from the list of products, wherein the product is integrated with a message medium, the message medium further comprising an intervention message that enables the online intervention, of the first user into the life situation of the second user;
affix a personalized message to the product; and
transmit the product to the second user.

22. The system as claimed in claim 21, wherein the intervention message is customized for the life situation of the second user.

23. The system as claimed in claim 21, wherein the personalized message is provided by the first user.

24. The system as claimed in claim 21, wherein the processor is further configured to determine a status, of the second user, on a social networking site, wherein the status comprises one or more keywords that determines the life situation of the second user.

25. The system as claimed in claim 21, wherein the processor is further configured to retrieve the product based on the life situation of the second user.
